(19) United States
(12) Patent Application Publication
(10) Pub. No.: US 2026/0168585 A1
(43) Pub. Date: Jun. 18, 2026

(54) SYSTEMS AND METHODS ASSOCIATED WITH A VALVE FOR INFLATABLE DEVICES

(71) Applicant: Mark Mower, Corpus Christi, TX (US)

(72) Inventor: Mark Mower, Corpus Christi, TX (US)

(21) Appl. No.: 19/374,796

(22) Filed: Oct. 30, 2025

Related U.S. Application Data
(60) Provisional application No. 63/733,044, filed on Dec. 12, 2024.

(51) Int. Cl. F16K 15/20

(52) U.S. Cl. CPC F16K 15/20

(57) ABSTRACT

A valve assembly for inflatable devices is disclosed. The valve assembly is configured to transition between an open configuration and a closed configuration. In the open configuration, air may automatically and continuously exit a bladder without further user interaction to facilitate deflation. In the closed configuration, the valve operates as a one-way check valve that allows air to enter the bladder but prevents air from exiting. The valve assembly includes a housing, an outer crown, an inner crown, a spring, and a flexible valve member.

### BACKGROUND INFORMATION

### Field of the Disclosure

Examples of the present disclosure are related to systems and methods associated with a valve for inflatable devices. More specifically, embodiments are directed towards a valve assembly that is configured to transition between an open and closed mode, wherein in the open mode a bladder can be continuously and automatically deflated without further interactions with the valve assembly. In the closed mode, the valve operates as a one-way check valve that allows air to enter the bladder but does not allow air to exit the bladder.

### Background

Flotation devices, swimming floats, and other “inflatables” are devices that utilize a bladder to retain and release air. When the bladder is inflated, the bladder can float on water. These devices come in many shapes, sizes, and types, and are used to aid with buoyancy or for floating for fun.

Generally, floatation devices include a valve that regulates, directs, or otherwise controls the flow of air by opening, closing, or partially obstructing various passageways. For example, an oral inflation valve is a type of valve with a cap that requires it to be opened to fill the object with air by placing the lips and blowing air inside it manually or using air pumps and closing after finishing. To deflate an object and make transport or storage easier, the cap can be opened for the air to be drained and the object can be squeezed, so the deflation process is quicker. This requires a user to apply constant pressure to the valve to deflate or inflate the bladder. Situations may occur where a user requires the use of both hands, such that the user is not able to interact with the bladder to inflate and/or deflate the bladder.

Other types of valves may include a passageway that operates as an inlet/outlet that is opened by a user unscrewing threads to expose the passageway. When the passageway is exposed, air may enter or exit the bladder. Upon inflating or deflating the bladder, the valve may be screwed to seal the passageway. These types of systems require a user to apply constant airflow to inflate the bladder, and situations may occur when a user cannot apply a constant flow to inflate the bladder.

Accordingly, a need exists for more effective and efficient systems and methods for a valve that transitions between an open and closed mode, wherein in the open mode a bladder can be continuously and automatically deflated without further interactions with the valve. In the closed mode, the valve operates as a one-way check valve.

### SUMMARY

Embodiments disclosed herein describe systems and methods for a valve that allows for a bladder to be continuously automatically deflated without user interaction in an open configuration and operates as a one-way check valve in a closed configuration that allows air to enter the bladder but does not allow air to exit the bladder. Embodiments may include a housing, outer crown, inner crown, spring, and valve.

The housing may be a substantially cylindrical device that is configured to secure the placement of the outer crown and inner crown within the housing. The housing may also be configured to control the axial movement of the outer crown and the axial and rotational movement of the inner crown. A distal end of the housing may include edges and slots. The slots may be guides configured to receive guides on the outer circumference of the outer crown and the inner crown to control the positioning of the outer crown and inner crown responsive to the inner crown sliding in and out of the slots. In embodiments, the inner sidewalls of the slots may also be configured to limit the rotational movement of the inner crown when the guides of the inner crown are positioned within the slots. The edges may include tapered edges that allow the guides of the inner crown to slide along the edges.

The outer crown may be a device that is configured to linearly move to allow the inner crown to linearly move and rotate. The outer crown may include guides and first jagged edges. The guides are configured to slide in and out of the slots to linearly move the outer crown. Responsive to a proximal end of the outer crown receiving a downward force, the outer crown may slide downward. This may allow second jagged edges on a proximal end of the inner crown to slide along the first jaggededges to rotate the inner crown relative to a rotationally fixed outer crown. As the downward force applied against the proximal end of the outer force is released, the outer crown and the inner crown may move upward together, and the guides on the inner crown into the slots on the housing.

The inner crown may be a rotational cam that is configured to linearly move and rotate. The rotation of the inner crown may be based on the first jagged edges and the second jagged edges. The inner crown may include a second set of jagged edges positioned on the proximal end of the inner crown. The second jagged edges are configured to rotate along the first jagged edges, and along the tapered surfaces of the housing to rotate the inner crown.

In embodiments, when the valve is in the open position, a guide of the inner crown may be positioned adjacent to the first tapered sidewall of the housing. This may maintain the valve in the open position. To transition the valve to the closed position, the outer crown may push the inner crown downward, clearing the first tapered surface of the housing, allowing the second jagged edge to rotate along the first jagged edges, and then moving the guides of the inner crown upward into the slots of the housing. This process can be repeated multiple times to open and close the valve. One skilled in the art may appreciate that this process is similar to a retractable pen to extend and retract the tip, wherein the tip of the retractable pen is replaced by the valve assembly. One skilled in the art may appreciate that the valve assembly may utilize any known means to transition between the open and closed position, wherein in the open position air is free to travel between the bladder and an environment, and in the closed position the valve assembly operates as a one way check valve that does not allow air to leave the bladder but allows air to enter the bladder.

The spring may be a device that is configured to apply a constant spring force against the inner crown. Responsive to the outer crown receiving a downward force, the outer crown may translate this force to the spring via the inner crown to compress the spring. When the downward force is released, the spring may elongate, pushing the inner crown upward such that the second jagged edges of the inner crown interface with the first jagged edges to rotate the inner crown. This upward movement of the inner crown will also push the outer crown upward to slide the guides within the slots.

The valve may be a flexible component that is configured to move along with the inner crown. The valve may have a plunger that is configured to couple the valve with the inner crown. The valve may include a radial flange that is configured to be positioned away from a ledge of the housing when the valve assembly is in the open position and on the ledge of the housing when the valve assembly is in the closed position. When the valve is in the open position, air may freely travel from the bladder, through an annulus between the inner crown and the housing, and out of the valve assembly. When the valve is in the closed position, the radial flange of the valve may be pulled upward by the inner crown, have a concave downward shape, and be positioned adjacent to the ledge. This may form a one-way seal between the radial flange and the ledge of the housing, sealing the inner passageway of the housing. Responsive to a user blowing air into the valve assembly, the air may enter the annulus, and push down against an upper surface of the radial flange causing the edges of the radial flange to bow inward. This may create a gap between the upper surface of the radial flange and the ledge, allowing the air to enter the bladder. When the user stops blowing air, the radial flange will elastically and automatically move back to its original position, forming the seal against the ledge.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein reference numerals refer to like parts throughout the various views unless otherwise specified.

FIG. 1 depicts a valve assembly in a closed position, according to an embodiment.

FIG. 2 depicts the valve assembly in the open position, according to an embodiment.

FIG. 3 depicts a method for alternating the valve assembly between a closed configuration and an open configuration, according to an embodiment.

FIG. 4 depicts different views of an embodiment of a housing.

FIG. 5 depicts various views of the inner crown, according to an embodiment.

FIG. 6 depicts various views of the outer crown, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art that the specific detail need not be employed to practice the present embodiments. In other instances, well-known materials or methods have not been described in detail to avoid obscuring the present embodiments.

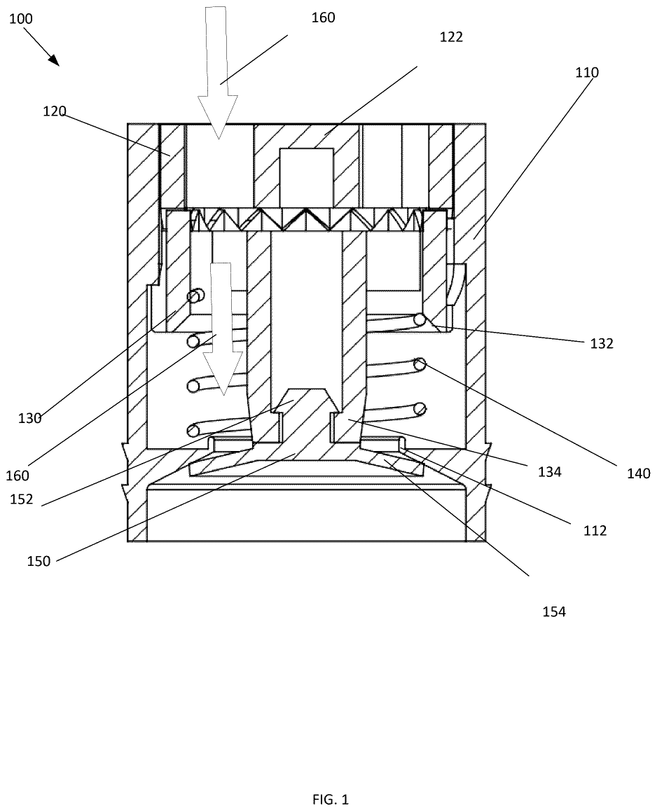

FIG. 1 depicts a valve assembly 100 in a closed position, according to an embodiment. Valve assembly 100 may be configured to change between an open configuration and a closed configuration. When valve assembly 100 is in the open configuration, air or other fluids may bi-directionally freely flow from a proximal end to a distal end of valve assembly 100. In the open configuration, air is free to exit a bladder to deflate, but may also allow bidirectional flow if the pressure differential reverses.

In the closed position, air or other fluids may not flow from a distal end of valve assembly 100 to the proximal end of valve assembly 100, but air or other fluids may flow from the proximal end of valve assembly 100, through valve assembly 100, and out of a distal end of valve assembly. When in the closed configuration, the valve allows airflow into but not out of the bladder, while in the open configuration, both inflow and outflow are unrestricted.

Valve assembly 100 may include a housing 110, outer crown 120, inner crown 130, spring 140, and valve 150.

Housing 110 may be formed of a rigid material and may be configured to house and secure the other elements of valve assembly 100. Housing 110 may include a hollow inner passageway, within which air 160 can flow through. Housing 110 may include a ledge 112 positioned within an inner circumference of housing 110. Ledge 112 may be a concave downward curve that gradually reduces the diameter across housing 110 from a distal end of housing 110 to a proximal end of housing 110. In embodiments, a diameter across ledge 112 may be less than a diameter across radial flange 154, and greater than a diameter across plunger 152. Responsive to positioning the radial flange 154 directly adjacent to ledge 112 a one-way seal may be formed through housing 110. Responsive to positioning the radial flange 154 away from ledge 112, bi-directional fluid flow through housing 110 may be enabled.

Outer crown 120 may be a device that is configured to sit within housing 110. Outer crown 120 may be configured to move axially within housing 110, without rotating, when a user presses button 122 positioned on a proximal end of the housing 110. Responsive to a user pressing button 122, outer crown 120 may move downward, moving inner crown 130 downward and compressing spring 140. This movement may cause valve assembly 100 to transition from the open position to the closed position, or vice versa. When the user no longer applies a downward force against outer crown 120, housing 110 may retain inner crown 130 in the downward position, and not allow outer crown 120 or inner crown 130 to slide upward. Responsive to the user pressing button 122 once again, housing 110 may release outer crown 120, and spring 140 may apply an upward force against inner crown 130 to push inner crown 130 to slide upward. In embodiments, outer crown 120 may include a hollow, radial passageway between the outer diameter of button 122 and an inner diameter of outer crown 120.

Inner crown 130 may be a device that is configured to sit within housing 110. Inner crown 130 may be configured to move axially downward and rotate within housing 110 responsive to outer crown 120 moving downward. This downward movement may cause spring 140 to compress. In embodiments, after sliding inner crown 130 downward and rotating inner crown 130, housing 110 may temporarily retain inner crown 130 in the downward position. This may retain valve assembly 100 in the open position. Responsive to moving outer crown 120 downhole a second time, inner crown 130 may be configured to rotate and move axially upward based on an upward spring force, based on spring 140 elongating. This may close the valve assembly 100.

In embodiments, inner crown 130 may include a ledge 132, nose 134, and a radial hollow passageway.

Ledge 132 may be positioned on the distal end of inner crown 130 and be configured to receive a constant spring force from spring 140. Ledge 132 may be shaped to retain spring 140, whether spring 140 is compressed or elongated.

Nose 134 may be aligned with a central axis of inner crown 130, and have a hollow distal end. The hollow distal end of nose 134 may be configured to receive and secure valve 150. In other embodiments, nose 134 may be configured to receive a proximal end of valve 150 via any known means, such as threads, press fit, dogs, collets, etc.

Inner crown 130 may also have a radial hollow passageway that extends from a proximal end of inner crown 130 to a distal end of inner crown 130. This may allow air to flow through the inner crown 130.

Spring 140 may be a device that is configured to apply a constant spring force against inner crown 130. In embodiments, responsive to the inner crown 130 applying a downward force against spring 140, spring 140 may compress to store energy. After the downward force against spring 140 is removed, the energy stored by spring 140 may be released, elongating spring 140, to move inner crown 130 upward.

Valve 150 may be a device that is formed of flexible material, such as silicon, rubber, etc. In embodiments, valve 150 may be constructed to be pliable when forces are applied against an upper surface of valve 150 in a first direction, but may be semi-rigid when forces are applied against a lower surface of valve 150 in a second direction. Valve 150 is a device that is configured to form a one-way seal against ledge 112, and to be positioned away from ledge 112 to allow bi-directional flow of fluid through valve assembly 100. In embodiments, responsive to inner crown 130 moving downward, valve 150 may correspondingly move downward to be positioned away from ledge 112. Responsive to the inner crown 130 moving upward, valve 150 may correspondingly move upward to be positioned adjacent to and contacting ledge 112. Valve 150 may include a plunger 152 and radial flange 154.

Plunger 152 may be positioned on the upper surface of the valve and may be an axial projection that is configured to couple with nose 134 of inner crown 130. In embodiments, plunger 152 may be configured to be press-fit into a hollow chamber within nose 134. However, one skilled in the art may appreciate that plunger 152 may be coupled with nose 134 in any known manner, such as via corresponding threads, dogs, collets, etc.

Radial flange 154 may be a radial projection extending away from the body of valve 150 that increases the diameter across valve 150. In embodiments, a diameter across radial flange 154 may be greater than a diameter across ledge 112 but less than an inner diameter across a distal end of housing 110. Radial flange 154 may have a downward concave curvature, which may increase the contact surface area between the upper surface of radial flange 154 and the lower surface of ledge 112 when radial flange 154 is positioned directly against ledge 112. The downward concave curvature may also allow the radial flange 154 to bow inward responsive to the radial flange 154 receiving pressure via airflow 160. Specifically, responsive to an upper surface of radial flange 154 receiving downward pressure, the outer edges of radial flange 154 may bow inward decreasing the diameter across radial flange 154. This movement may expose a passageway between the upper surface of radial flange 154 and the lower surface of ledge 112 when the valve assembly is in the closed position. Responsive to the downward pressure against the upper surface of radial flange 154 being removed, radial flange 154 may automatically bow outward to once again form a seal against the lower surface of ledge 112.

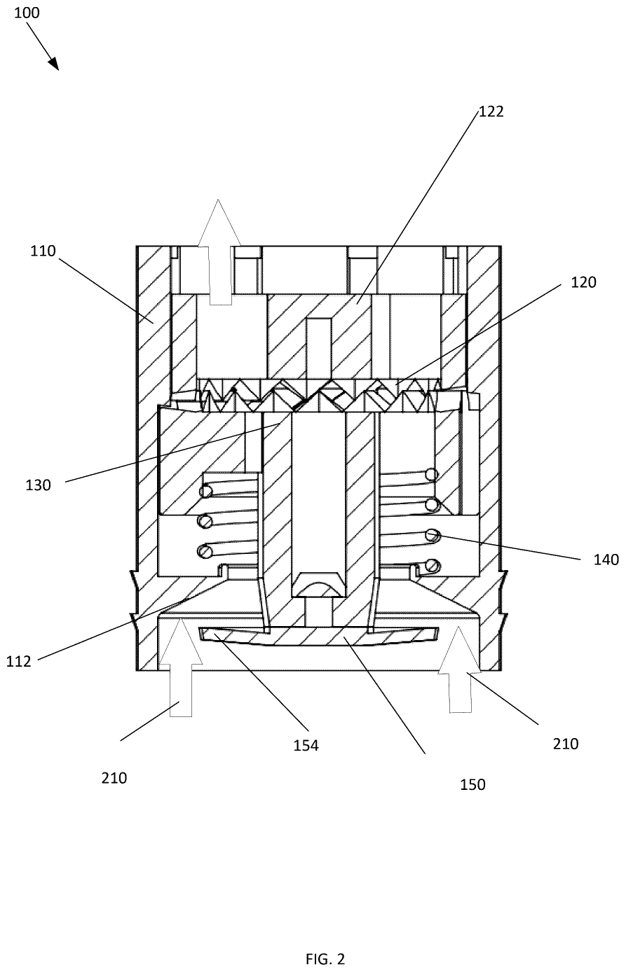

FIG. 2 depicts an embodiment of valve assembly 100 being in the open position. As depicted in FIG. 2, responsive to button 122 on the proximal end of outer crown 120 being pressed, these forces may be utilized to compress spring 140 and slide inner crown 130 downward. In embodiments, after the inner crown 130 slides downward, a profile on an inner diameter of housing 110 may be utilized to temporarily secure the inner crown 130 in a downward position. When inner crown 130 is in the downward position, the upper surface of radial flange 154 may be positioned away from the lower surface of ledge 112. This may create a passageway where air 210 from a bladder 210 may flow upward through valve assembly 100.

In embodiments, responsive to pressing button 122 down a second time, inner crown 130 may become disengaged from the profile on the housing 110, allowing the spring 140 to apply an upward force against inner crown 130 to revert valve assembly 100 to the closed position shown in FIG. 1.

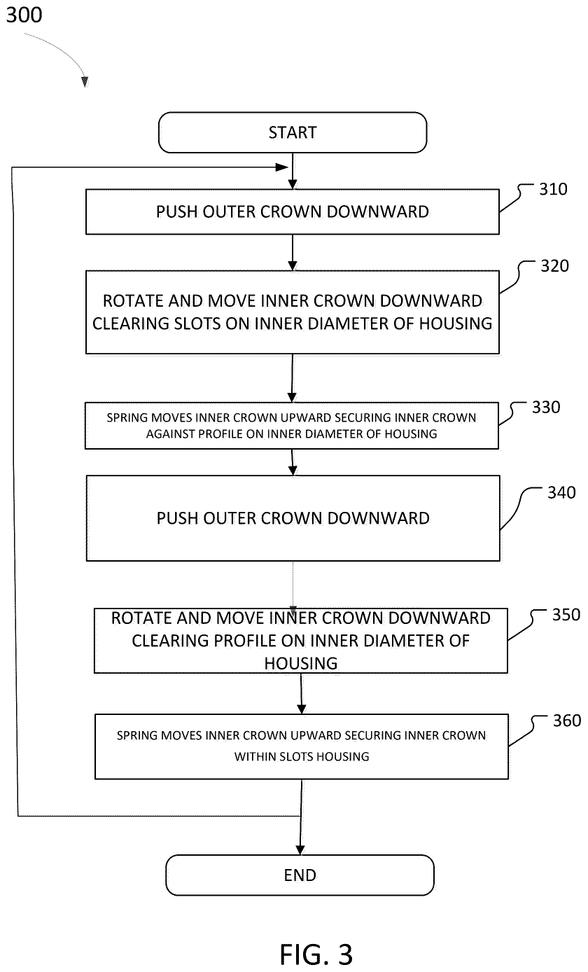

FIG. 3 depicts a method 300 for alternating the valve assembly between a closed configuration and an open configuration, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

At operation 310, while the valve assembly is in the closed configuration, the radial flange of the valve may be positioned directly adjacent to a ledge of the housing. This may form a one-way seal through the housing. A user may press down on an outer crown, positioned radially within the housing.

At operation 320, this may push down the inner crown, causing the inner crown to move downward, and a spring to compress. While the outer crown moves downward, the outer crown causes the inner crown to rotate slightly via corresponding grooves between the inner crown and the outer crown. As the inner crown rotates and moves downward, the edges of the inner crown may clear slots on the housing.

At operation 330, responsive to clearing the notches on the inner diameter of the housing, the spring force against the inner crown may cause edges on the upper surface of the inner crown to mate and rotate with edges on the lower surface of the outer crown at an angle. This rotation of the inner crown may occur until the sidewalls of the edges on the inner crown contact notches on the tapered surface of the housing. This may retain the valve assembly in the open position.

At operation 340, the user may once again push down on the outer crown. This may push down the inner crown, causing the inner crown to move downward, and a spring to compress. While the outer crown moves downward, the outer crown causes the inner crown to rotate slightly via corresponding grooves between the inner crown and the outer crown. As the inner crown rotates and moves downward, the edges of the inner crown may clear the tapered surface of the housing and become aligned with the slots within the housing.

At operation 350, responsive to releasing the pressure applied to the outer crown, the upward spring force may move guides on the outer diameter of the inner and outer crown into the slots within the housing.

At operation 360, the spring may apply an upward force against the inner crown to retain the guides on the outer diameter of the inner and outer crown within the slots to retain the valve assembly in the closed position.

This process can be repeated numerous times to open and close the valve assembly.

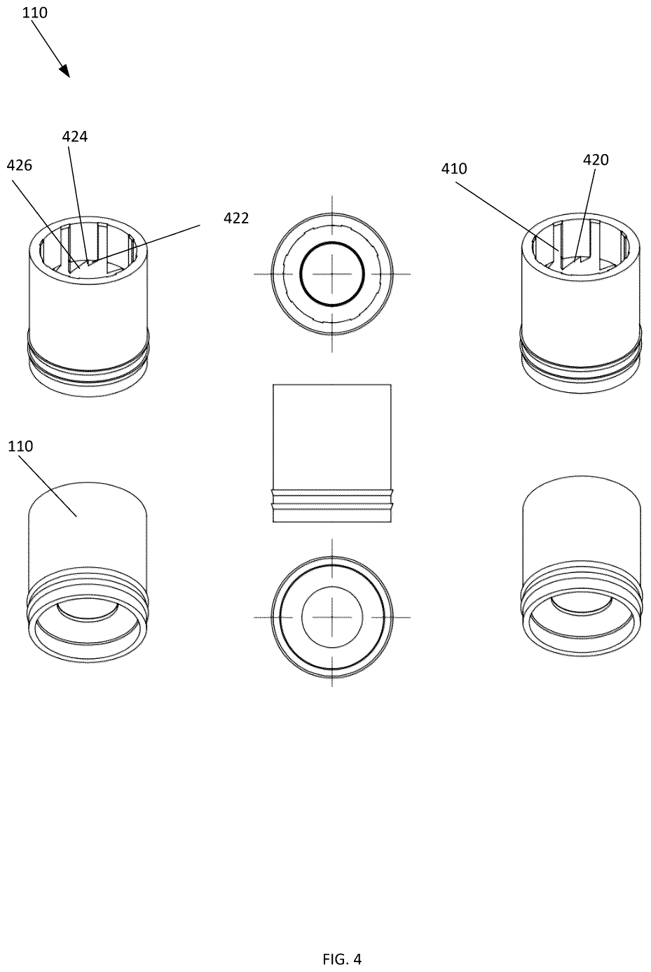

FIG. 4 depicts different views of an embodiment of housing 110. In embodiments, while the outer crown or inner crown are moving axially, housing 110 may be configured to be relatively fixed in place. Housing 110 may include slots 410, and a tapered surface 420.

Slot 410 may extend axially from a proximal end to a distal end of housing 110, and may include an open lower surface. When the valve assembly is in the closed position, guides positioned on the outer sidewalls of the inner or outer crown may be positioned within the slots.

Tapered surface 420 may be a jagged surface, with a first surface 422, a sidewall 424, and a second surface 426. In embodiments, responsive to depressing the outer crown downward, second jagged surfaces on the inner crown may clear slots 410 while the guides of the outer crown remain in the slots. When the second jagged surfaces clear the slots 410, the second jagged surfaces may rotate along the first jagged edges on the outer crown, until the second jagged edges clear the first surface 422.

When the second jagged edges clear the sidewall 424 and the force is released, the spring may cause an upward force against the inner crown to push the second jagged edges between the first surface 422 and second surface 426. This may lock the valve assembly in the open position.

Responsive to once again depressing the outer crown, an outer crown may apply a downward force against the inner crown, mating the first jagged edges on the outer crown with the second jagged edges on the inner crown. The second jagged surfaces may rotate along the first jagged edges on the outer crown until the second jagged edges clear the first surface 422 and the first jagged edges. When the downward force is removed from the outer crown, the guides positioned on the inner crown may once again be positioned within the slots 410.

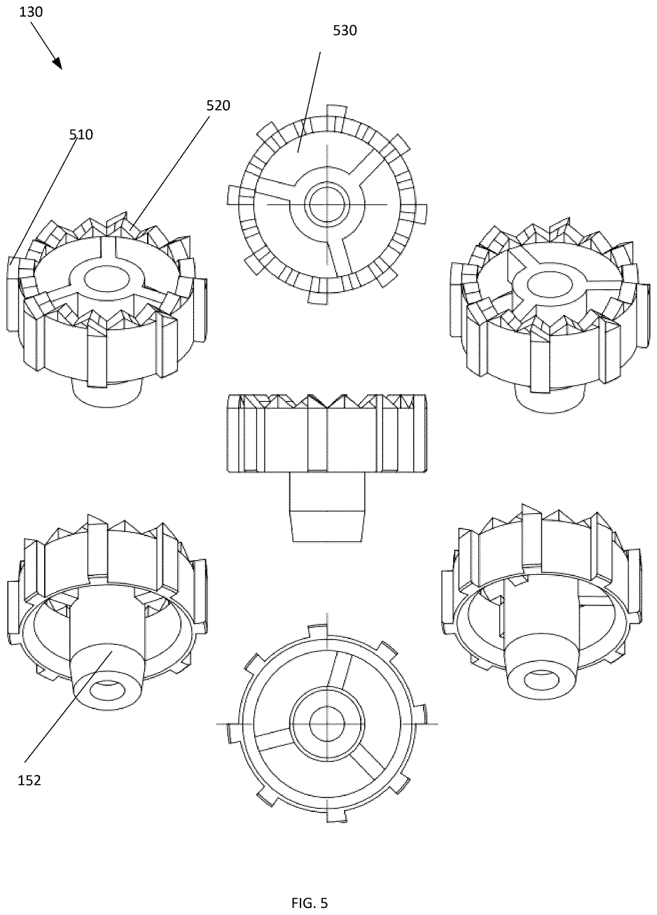

FIG. 5 depicts various views of the inner crown 130 according to an embodiment. As depicted in FIG. 5, inner crown 130 may include second jagged edges 520 that include a first slope and a second slope. The first slope and second slope of jagged edges may be configured to interface with the tapered surface of the housing and the first jagged edges of the outer crown to allow the inner crown 130 to rotate and move axially.

In embodiments, guide 510 may be positioned on an outer circumference of the inner crown 130. However, guide 510 may only be aligned with the first slope of the inner crown. This may allow the diameter of the inner crown 130 to be greatest along the guide 510. As such, guide 510 may be positioned adjacent to the second surface 426 of housing 110 when the valve assembly 100 is in the closed position, and within slots 410 when the valve assembly 100 is in the open position. Further, the increase in diameter may cause the inner crown 130 to be locked within the slots 410 until the proximal end of guides 510 clear the distal ends of the slots.

As further depicted in FIG. 5, inner crown 130 may include a hollow inner diameter 530, which allows air to travel through the inner crown.

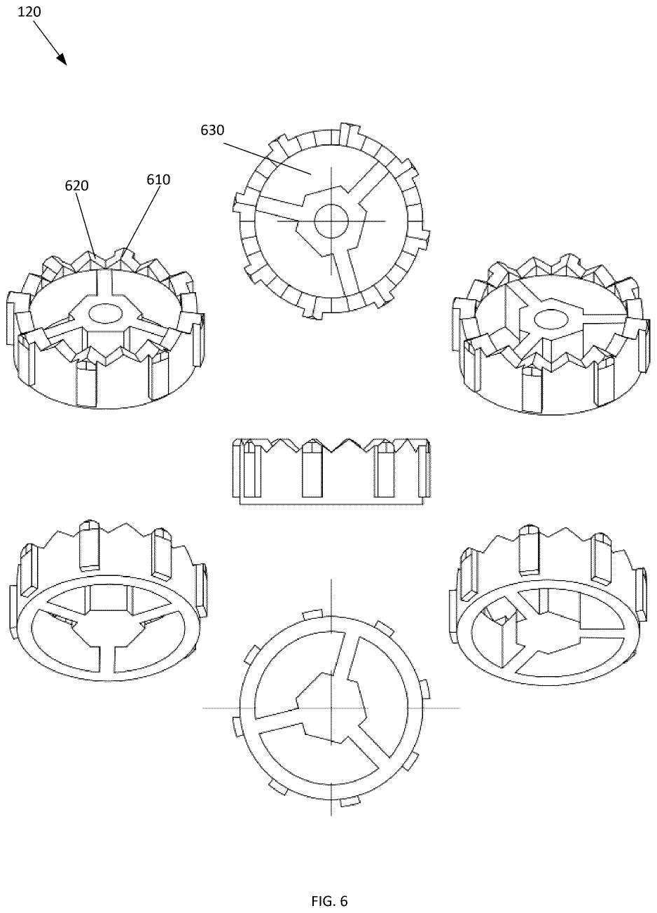

FIG. 6 depicts various views of outer crown 120 according to an embodiment. As depicted in FIG. 6, outer crown 120 may include first jagged edges 620 that include a first slope and a second slope. The first slope and second slope of jagged edges may be configured to interface with the second jagged edges of the inner crown 130 to allow the inner crown 130 to rotate and move axially. Specifically, responsive to pressing the outer crown 120 downward, the first jagged edges 620 may push downward, causing the second jagged edges 520 to rotate.

In embodiments, guide 610 may be positioned on an outer circumference of the outer crown 120. Guide 610 may be aligned with both the first and second slopes of outer crown 120. This may allow the diameter across guides 610 to be greater than areas without the guides, such that guides 610 may always be positioned within slots 410.

As further depicted in FIG. 6, outer crown 120 may include a hollow inner diameter 630, which allows air to travel through the inner crown.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A valve assembly for an inflatable bladder, comprising:
a housing having an inner passageway and a ledge positioned within an inner circumference of the housing;
an outer crown configured to move axially within the housing;
an inner crown disposed within the housing and configured to move axially and rotationally relative to the outer crown; wherein the inner crown and outer crown include corresponding jagged edges configured to mechanically interact such that successive axial depressions of the outer crown toggle the valve assembly between an open configuration and a closed configuration;
a spring positioned between the housing and the inner crown, the spring configured to store and release energy to bias the inner crown toward an initial position; and
a valve coupled to the inner crown and having a plunger and a radial flange, in the open configuration, the radial flange is spaced away from the ledge to allow continuous air flow through the housing to deflate the bladder, wherein in the closed configuration, the radial flange contacts the ledge to form a one-way seal that allows air to enter but not exit the bladder.

2. The valve assembly of claim 1, wherein the radial flange of the valve is formed of flexible material.

3. The valve assembly of claim 1, wherein in the closed configuration the radial flange has a downward concave curvature that elastically deforms to allow airflow into the inflatable bladder when air pressure is applied against an upper surface of the flange.

4. The valve assembly of claim 3, wherein in the open configuration the radial flange has an upward concave curvature.

5. The valve assembly of claim 2, wherein the spring is positioned an upper surface of the ledge.

6. The valve assembly of claim 5, a valve coupled to the inner crown and having a plunger and a radial flange, in the open configuration, the radial flange is spaced away from the ledge to allow continuous air flow through the housing to deflate the inflatable bladder, wherein in the closed configuration, the radial flange contacts the ledge to form a one-way seal that allows air to enter but not exit the inflatable bladder.

7. The valve assembly of claim 2, wherein the radial flange of the valve is formed of flexible material.

8. The valve assembly of claim 7, wherein in the closed configuration the radial flange contacts a lower surface of the ledge.

9. The valve assembly of claim 8, wherein the lower surface of the ledge is tapered to create the downward concave curvature of the radial flange.

10. The valve assembly of claim 1, wherein the valve assembly and the inflatable bladder is positioned within an article of clothing to act as a flotation device.

11. The valve assembly of claim 1, wherein in the closed configuration the radial flange and the ledge form an annular seal that prevents air from exiting the bladder when internal pressure exceeds external pressure.
